(19) United States
(12) Patent Application Publication
(10) Pub. No.: US 2011/0013404 A1
(43) Pub. Date: Jan. 20, 2011

(54) INFORMATION OUTLET

(75) Inventors: Satoru Ueno, Osaka-shi (JP); Toshiaki Inage, Suzuka-shi (JP)

Correspondence Address: EDWARDS ANGELL PALMER & DODGE LLP, P.O. BOX 55874, BOSTON, MA, 02205, US

(73) Assignee: Panasonic Electric Works Co., Ltd., Osaka (JP)

(21) Appl. No.: 12/735,182

(22) PCT Filed: Dec. 18, 2008
(86) PCT No.: PCT/JP2008/073060

§ 371 Date: Sep. 7, 2010

(30) Foreign Application Priority Data
Dec. 18, 2007 (JP) 2007-326340

(51) Int. Cl. F21V 15/00

(52) U.S. Cl. 362/362

(57) ABSTRACT

The information outlet (1) includes a housing (10) shaped into a rectangular box. The housing (10) is integrally formed on its front surface with a rectangular boss portion (11). The boss portion 11 is formed in its center with a cylindrical recess (16). An inner terminal receiving member (14) and outer terminal receiving member (15) are disposed inside the recess (16). Applied between the inner terminal receiving member (14) and outer terminal receiving member (15) is DC voltage where a video signal is superimposed. Interposed between the inner terminal receiving member (14) and outer terminal receiving member (15) is a light emitting diode which emits light upon being applied DC voltage to. The light emitted from the light emitting diode is transmitted to an outside of the housing (10) via a translucency window portion (13).

### TECHNICAL FIELD

The present invention is directed to an information outlet such as an information modular jack for LAN and a TV outlet.

### BACKGROUND ART

In the past, there have been proposed various types of information outlets (e.g. an information modular jack, a TV outlet, and the like). For example, Japanese Non-examined Patent Publication No. 2000-48897 discloses an information outlet embedded into a wall so as to expose its front surface. It is noted that a fixture frame is used for embedding the information outlet into the wall.

The information outlet disclosed in the above Japanese Non-examined Patent Publication includes a case shaped into an approximately rectangular box. The case is provided on its front surface with a plug insertion slot adapted in use to be inserted a modular plug into. Further, a plurality of contacts (terminal receiving member) is housed in the case. The contact is configured to be electrically connected to a terminal of the modular plug inserted into the case from the plug insertion slot.

The aforementioned information outlet is used for transmission of various kinds of data signals (e.g. a data signal for LAN and a video signal for TV).

Recently, there have been proposed information outlets capable of not only transmitting a data signal but also supplying DC power. These kinds of information outlets are configured to superimpose a data signal on DC voltage in order to use a signal line for transmission of the data signal as a power line for DC power.

In the aforementioned information outlet, the almost case has a shape specified by a standard. Therefore, the case of the information outlet capable of supplying DC power is likely to have the same exterior appearance as the case of the information outlet not capable of supplying DC power.

Accordingly, with reference to an exterior appearance of the information outlet, it is difficult to judge whether or not DC power is supplied to the terminal receiving member. Therefore, when a user intends to connect a device to the information outlet having the terminal receiving member receiving DC power, the user is likely to mistakenly connect the device to the information outlet having the terminal receiving member not receiving DC power.

### DISCLOSURE OF INVENTION

In view of above insufficiency, the purpose of the present invention has been aimed to provide an information outlet enabling a user to easily judge whether or not DC power is being supplied.

The information outlet in accordance with the present invention includes a case, and a plug connection unit provided to the case and adapted in use to be detachably connected to a plug. The plug connection unit is configured to send a data signal to the plug and supply DC power to the same. The case is provided with a display unit configured to indicate a status that the DC power is being available.

According to this invention, by means of watching the display unit provided to the case, a user can easily judge whether or not the DC power is being supplied.

In the preferred embodiment, the display unit includes an illuminant electrically connected to the plug connection unit. The illuminant is configured to emit light by use of DC power supplied to the plug connection unit.

According to this embodiment, the illuminant emits light while the DC power is supplied to the plug connection unit, and does not emit the light while the DC power is not supplied to the plug connection unit. Therefore, by means of watching the illuminant, a user can easily judge whether or not the DC power is being supplied. Further, the illuminant emits the light by use of the DC power supplied to the plug connection unit. In short, it is unnecessary to provide a power source configured to light the illuminant. It is possible to suppress the rise in a production cost.

### BRIEF DESCRIPTION OF DRAWINGS

FIG. 1 is a perspective view illustrating an information outlet in accordance with a first embodiment,

FIG. 2A is a front view illustrating the above information outlet,

FIG. 2B is a front view illustrating the above information outlet of another embodiment,

FIG. 3 is an exploded perspective view illustrating the above information outlet,

FIG. 4 is a circuit diagram illustrating the above information outlet,

FIG. 5 is a perspective view illustrating an information outlet in accordance with a second embodiment,

FIG. 6A is a front view illustrating the above information outlet,

FIG. 6B is a front view illustrating the above information outlet of another embodiment,

FIG. 7 is a chart illustrating assignment of pins of a twisted pair cable connected to the above information outlet,

FIG. 8 is a circuit diagram illustrating a plug connection unit of the above information outlet, and

FIG. 9 is a schematic view illustrating a home system including the information outlet in accordance with the present invention.

### BEST MODE FOR CARRYING OUT THE INVENTION

In the following embodiments, a house H of a single-family dwelling is exemplified as a building where an information outlet in accordance with the present invention is applied. However, the information outlet in accordance with the present invention can be applied to a housing complex.

A DC power supply unit 101 configured to output DC power and a DC device 102 are placed in the house H. The DC device 102 is a load activated by DC power. DC power is supplied to the DC device 102 via a DC supply line Wdc connected to an output terminal of the DC power supply unit 101. A DC breaker 114 is interposed between the DC power supply unit 101 and the DC device 102. The DC breaker 114 is configured to monitor current flowing through the DC supply line Wdc and to limit or terminate electrical power supply from the DC power supply unit 101 to the DC device 102 via the DC supply line Wdc upon detecting an abnormal state.

The DC supply line Wdc is adopted as a power line for DC power as well as a communication line. For example, it is possible to communicate between devices connected to the DC supply line Wdc by means of superimposing on a DC voltage a communication signal used for transmitting a data and made of a high-frequency carrier. This technique is similar to a power line communication technique where a communication signal is superimposed on an AC voltage applied to a power line for supplying an AC power.

The aforementioned DC supply line Wdc is connected to a home server 116 via the DC power supply unit 101. The home server 116 is a primary device for constructing a home communication network (hereinafter called “home network”). The home server 116 is configured to communicate with a subsystem constructed by the DC device 102 in the home network, for example.

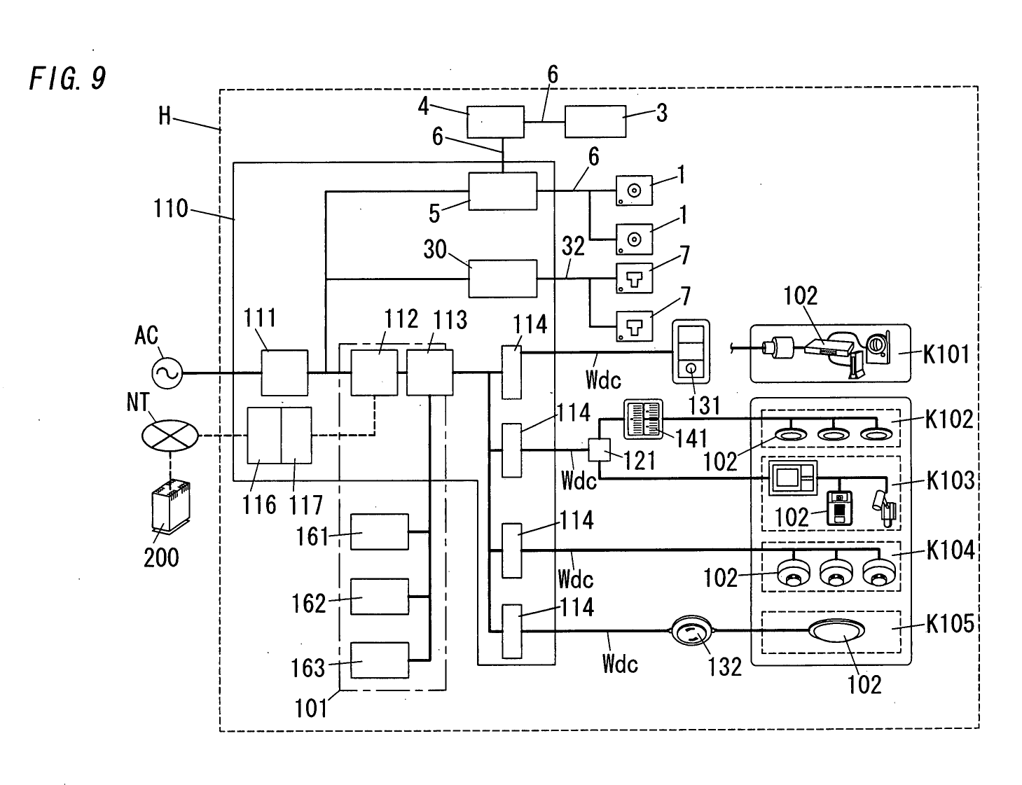

In the instance shown in FIG. 9, an information system K101, lighting systems K102 and K105, an entrance system K103, and a home alarm system K104 are adopted as the subsystems. The each subsystem is an autonomous distributed system, and operates by itself. The subsystem is not limited to the aforementioned instance.

The DC breaker 114 is associated with the subsystem. In the instance shown in FIG. 9, each of the information system K101, a pair of the lighting system K102 and entrance system K103, the home alarm system K104, and the lighting system K105 is associated with one DC breaker 114. A connection box 121 is provided to associate one DC breaker 114 with a plurality of the subsystems. The connection box 121 is configured to divide a system of the DC supply line for each subsystem. In the instance shown in FIG. 9, the connection box 121 is interposed between the lighting system K102 and the entrance system K103.

The information system K101 includes the informational DC device 102 such as a personal computer, a wireless access point, a router, and an IP telephone transceiver. This DC device 102 is connected to a DC socket 131 preliminarily provided to the house H (provided at the time of constructing the house H) as a wall outlet or a floor outlet, for example.

Each of the lighting systems K102 and K105 includes the lighting DC device 102 such as a lighting fixture. In the instance shown in FIG. 9, the lighting system K102 includes the lighting fixture (DC device 102) preliminarily provided to the house H. It is possible to send a control instruction to the lighting fixture of the lighting system K102 by use of an infrared remote controller. Further, the control instruction can be sent by transmitting a communication signal from a switch 141 connected to the DC supply line Wdc. In short, the switch 114 has a function of communicating with the DC device 102. In addition, the control instruction can be sent by transmitting a communication signal from the home server 116 or from other DC device 102 of the home network. The control instruction for the lighting fixture indicates such as turning on, turning off, dimming, and blinking. Meanwhile, the lighting system K105 includes the lighting fixture (DC device 102) connected to a ceiling-mounted hooking receptacle 132 preliminarily provided on a ceiling. It is noted that the lighting fixture is attached to the ceiling-mounted hooking receptacle 132 by a contractor at the time of constructing an interior of the house H or attached to the ceiling outlet 132 by a resident of the house H.

The entrance system K103 includes the DC device 102 configured to respond to a visitor and to monitor an intruder.

The home alarm system K104 includes the alarm type DC device 102 such as a fire alarm.

Any DC device 102 can be connected to each of the aforementioned DC socket 131 and ceiling-mounted hooking receptacle 132. Each of the DC socket 131 and ceiling-mounted hooking receptacle 132 outputs DC power to the connected DC device 102. Therefore, the DC socket 131 and ceiling-mounted hooking receptacle 132 are hereinafter collectively called the “DC outlet”, when a distinction between the DC socket 131 and the ceiling-mounted hooking receptacle 132 is unnecessary. A case of the DC outlet has a connection slot (plug-in connection slot) for inserting a terminal of the DC device 102. A terminal receiving member configured to directly contact to the terminal which is inserted into the connection slot is housed in the case of the DC outlet. In short, the DC outlet with above mentioned configuration makes contact-type power supply. The DC device with a communication function is capable of transmitting a communication signal via the DC supply line Wdc. The communication function is provided to not only the DC device 102 but also DC outlet. It is noted that the terminal is directly attached to the DC device 102 or is attached to the DC device 102 via a connection wire.

The home server 116 is connected to not only the home network but also the wide area network NT constructing Internet. While the home server 116 is connected to the wide area network NT, a user can enjoy service provided by a center server (computer server) 200 connected to the wide area network.

The center server 200 provides service capable of monitoring or controlling a device (which is mainly the DC device 102, but which may be other apparatus having a communication function) connected to the home network via the wide area network NT, for example. The service enables monitoring or controlling a device connected to the home network by use of a communication terminal (not shown) having a browsing function such as a personal computer, an internet TV, and a mobile telephone equipment.

The home server 116 has both a function of communicating with the center server 200 connected to the wide area network NT and a function of communicating with a device connected to the home network. The home server 116 further has a function of collecting identification information (assumed as “IP address” in this instance) concerning a device of the home network. The home server 116 and center server 200 mediate a communication between a home device and a Communication terminal in the wide area network NT. Therefore, it is possible to monitor or control the home device by use of the communication terminal.

When a user attempts to monitor or control the home device by use of the communication terminal, the user controls the communication terminal so as to store a monitoring request or a control request in the center server 200. The device placed in the house establishes periodically one-way polling communication, thereby receiving the monitoring request or control request from the communication terminal. According to the aforementioned operation, it is possible to monitor or control the device placed in the house by use of the communication terminal. When an event (such as fire detection) of which the home device should notify the communication terminal occurs, the home device notifies the center server 200 of occurrence of the event. When the center server 200 is notified of the occurrence of the event by the home device, the center server 200 notifies the communication terminal of the occurrence of the event by use of an e-mail.

A function of communicating with the home network of the home server 116 includes an important function of detecting and managing a device constructing the home network. By means of utilizing UPnP (Universal Plug and Play), the home server 116 automatically detects a device connected to the home network. The home server 116 further includes a display device 117 having a browsing function, and controls the display device 117 to display a list of the detected device. The display device 117 includes a touch panel or another user interface unit. Therefore, it is possible to select a desired one from options displayed on a screen of the display device 117. Accordingly, a user (a contractor or a resident) of the home server 116 can monitor and control the device through the screen of the display device 117. The display device 117 may be separated from the home server 116.

The home server 116 manages information with relation to connection of a device. For example, the home server 116 stores a type or a function and an address of the device connected to the home network. Therefore, it is possible to make a linked operation between devices of the home network. As described in the above, the information with relation to connection of a device is automatically detected. In order to make the linked operation between the devices, it is sufficient that an association between devices is automatically made by an attribution of a device. An information terminal such as a personal computer may be connected to the home server 116. In this case, the association between devices can be made by use of a browsing function of the information terminal.

Each of the devices holds a relation with regard to the linked operations between the devices. Therefore, the devices can make the linked operation without requiring to access to the home server 116. After establishing an association with regard to the linked operation of respective devices, a lighting fixture, which is one of the devices, is caused to turn on and off by manipulation of a switch, which is another of the devices, for example. Although the association with regard to the linked operation is made for the devices belonging to the same subsystem, the association with regard to the linked operation may be made for the devices belonging to the different subsystems.

The DC supply unit 101 is configured to basically generate DC power from AC power supplied from an AC power source (for example a commercial power source located outside) AC. In the instance shown in FIG. 9, the AC power source AC is connected to an AC/DC converter 112 including a switching regulator via a main breaker 111. The main breaker 111 is embedded in a distribution board 110. DC power output from the AC/DC converter 112 is supplied to each DC breaker 114 via a cooperation control unit 113.

The DC supply unit 101 is provided with a secondary cell 162 in view of a period (blackout period of the commercial power source) in which the DC supply unit 101 fails to receive electrical power from the AC power source AC. A solar cell 161 and fuel cell 163 configured to generate DC power can be used together with the secondary cell 162. The solar cell 161, secondary cell 162, and fuel cell 163 respectively are a dispersed power source, in view of a main power source including the AC/DC converter 112. In the instance shown in FIG. 9, the solar cell 161, secondary cell 162, and fuel cell 163 respectively include a circuit unit configured to control its output voltage. The solar cell 161 further includes not only a circuit unit of controlling electrical discharge but also a circuit unit of controlling electrical charge.

Although the solar cell 161 and fuel cell 163 of the dispersed power sources are dispensable, the secondary cell 162 is preferred to be provided. The secondary cell 162 is charged by the main power source or the other dispersed power source at the right time. The secondary cell 162 is discharged during a period in which the DC supply unit 101 fails to receive electrical power from the AC power source AC. In addition, the secondary cell 162 is discharged at the right time as necessary. The cooperation control unit 113 is configured to control discharge and charge of the secondary cell 162 and to make cooperation between the main power source and the dispersed power source. In short, the cooperation control unit 113 functions as a DC power control unit configured to control distributing to the DC device 102 electrical power from the main power source and dispersed power source constituting the DC supply unit 101. It is noted that DC power from the solar cell 161, secondary cell 162, and fuel cell 163 may be input to the AC/DC converter 112 by converting into AC power.

A drive voltage of the DC device 102 is selected from different voltages respectively suitable to individual devices of different voltage requirements. For this purpose, the cooperation control unit 113 is preferred to include a DC/DC converter configured to convert DC voltage from the main power source and dispersed power source into a desired voltage. Normally, a fixed voltage is applied to one subsystem (or the DC device 102 connected to one particular DC breaker 114). However, different voltages may be selectively applied to one subsystem by use of three or more lines. Use of two wired DC supply line Wdc can vary the voltage applied between wires with time. The DC/DC converter can be placed at plural points in a similar fashion as the DC breakers.

In the instance shown in FIG. 9, only one AC/DC converter 112 is provided. However, a plurality of AC/DC converters 112 may be connected in parallel to each other. When the plurality of the AC/DC converters 112 is provided, it is preferred to vary the number of the AC/DC converters 112 being activated in accordance with a magnitude of the load.

The aforementioned AC/DC converter 112, cooperation control unit 113, DC breaker 114, solar cell 161, secondary cell 162, and fuel cell 163 respectively are provided with a communication function. Therefore, the linked operation can be performed in response to status of each of the main power source, dispersed power source, and loads including the DC device 102. Like a communication signal used for the DC device 102, a communication signal used by the communication function is transmitted by being superimposed on DC voltage.

In the instance shown in FIG. 9, in order to convert AC power output from the main breaker 111 into DC power, the AC/DC converter 112 is placed in the distribution panel 110. However, the AC/DC converter 112 is not necessarily placed in the distribution panel 110. For example, branch breakers (not shown) may be connected to an output side of the main breaker 111 in the distribution panel 110 such that a plurality of systems is branched off from an AC supply line, and an AC/DC converter may be provided to an AC supply line of each of the systems. That is, each system may be provided with an apparatus configured to convert AC power into DC power. In this instance, it is possible to provide the DC supply unit 101 to each unit such as a floor or room of the house H. Accordingly, it is possible to manage the DC supply unit 101 for each system. In addition, it is possible to shorten a distance between the DC supply unit 101 and the DC device 102 configured to utilize DC power. Therefore, it is possible to reduce power loss caused by a voltage drop which occurs in the DC supply line Wdc. Alternatively, the main breaker 111 and branch breaker may be housed in the distribution panel 110, and the AC/DC converter 112, cooperative control unit 113, DC breaker 114, and home server 116 may be placed in another panel different from the distribution panel 110.

The information outlet in accordance with the present invention is used in the aforementioned home system (for example, as the DC outlet). Next, a detailed explanation is made to the information outlet in accordance with the present invention.

### First Embodiment

The information outlet 1 of the present embodiment is a TV outlet, for example. As shown in FIG. 9, the TV outlet is used for transmitting an electrical signal corresponding to a radio wave received by an antenna 3 placed outside the house H to a TV receiver or the like placed inside the house H. In the instance shown in FIG. 9, a receiving amplifier 4 configured to amplify the electrical signal from the antenna 3, and a distributor (external device) 5 configured to distribute the electrical signal to a plurality of the information outlets 1 are interposed between the antenna 3 and the information outlet 1. The antenna 3 is electrically connected to the receiving amplifier 4 by a coaxial cable 6, and the receiving amplifier 4 is electrically connected to the distributor 5 by a coaxial cable 6, and the distributor 5 is electrically connected to the information outlet 1 by a coaxial cable 6,

The coaxial cable 6 is adapted in use to transmit an audio signal, a video signal, or the like. The coaxial cable 6 includes an inner conductor 61 made of such as an electrical conductor (e.g. Coppers) having superior electrical conductivity. The inner conductor 61 is surrounded by an insulating layer 62 made of such as polyethylene resins. The insulating layer 62 is surrounded by an outer conductor 63 made of a braided wire manufactured by weaving copper fine wires. The outer conductor 63 is surrounded by a sheath (protective coat). In the coaxial cable 6, to apply a voltage between the inner conductor 61 and the outer conductor 63 causes a transmission of an electrical signal such as an audio signal and a video signal (data signal).

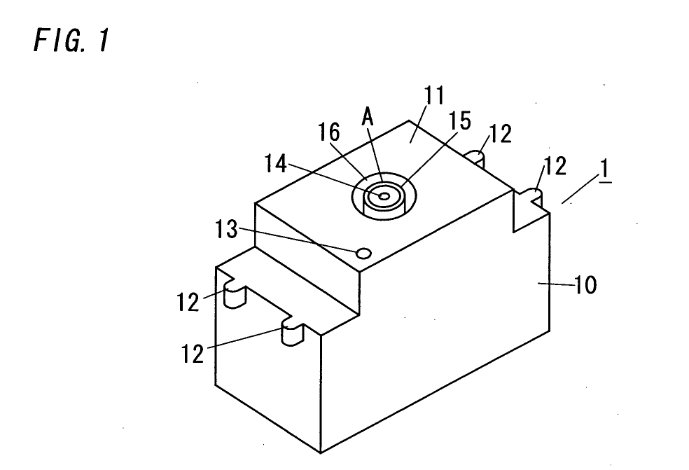

As shown in FIGS. 1 to 3, the information outlet 1 of the present embodiment includes a housing (case) 10. The housing 10 houses an inner terminal receiving member 14, an outer terminal receiving member 15, a shield plate 16, and a dielectric plate 19. The housing 10 further houses a light emitting diode (illuminant) LD1 and a resistor R1. The information outlet 1 is embedded into a building part such as a wall with being attached to a fixture frame (not shown). The fixture frame is specified by JIS (JIS C 8375) or the like.

The housing 10 is a synthetic resin molded product and is shaped into an approximately rectangular box. The housing 10 is dimensioned in match with a single module of an embedded wiring receptacle specified in accordance with the Japanese Industrial Standards [JIS] (JIS C 8304) such that three housings can be accommodated within an opening of the fixture frame as being arranged side-by-side in a longitudinal direction of the opening. The housing 10 is formed at each of its opposite longitudinal ends with two latch protrusions 12 for securement to the fixture frame. The housing 10 is secured to the fixture frame with the latch protrusions 12 being engaged with corresponding catches (not shown) of the fixture frame. The housing has its entire rear face (lower end as seen in FIG. 1) opened.

The housing 10 is integrally formed on its front surface (upper surface in FIG. 1) with an approximately rectangular boss portion 11. The boss portion 11 is formed to have a length along its longitudinal direction approximately identical to an opening length along a lateral direction of the opening window. The boss portion 11 is formed in its center with a cylindrical recess 16.

Each of the inner terminal receiving member 14 and outer terminal receiving member 15 used as contact is disposed inside the recess 16. The inner terminal receiving member 14 and outer terminal receiving member 15 are arranged so as to share the same center axis.

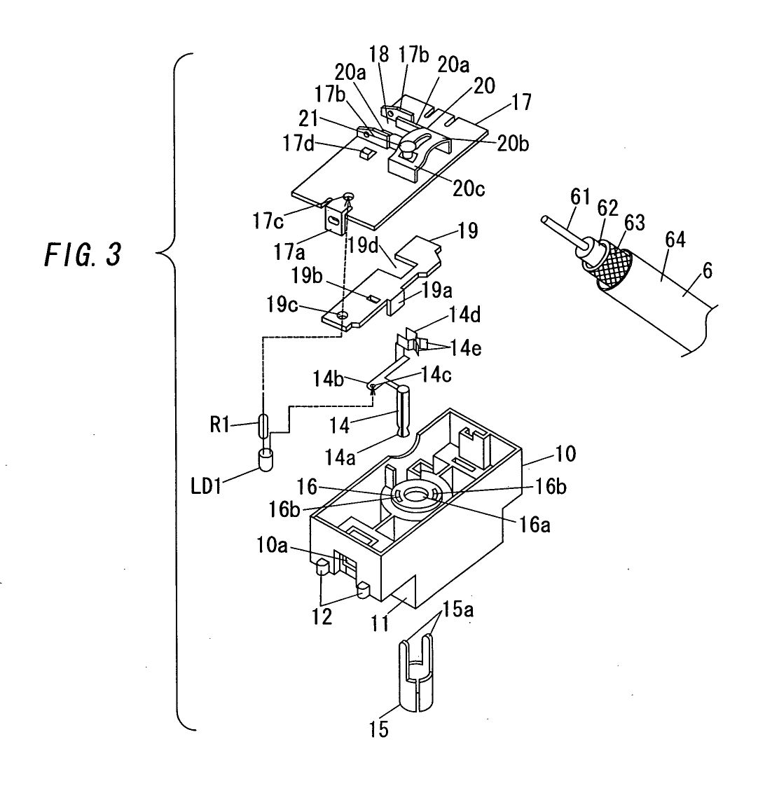

The outer terminal receiving member 15 is shaped into an approximately cylindrical shape, and is made of metals. The outer terminal receiving member 15 is integrally formed with a pair of legs 15a at its first end (upper end in FIG. 3) in its axial direction. Each of the legs 15a of the outer terminal receiving member 15 is inserted into the housing 10 through a hole 16b formed in a bottom of the recess 16.

The inner terminal receiving member 14 is made of metals and is formed with a pin holder 14a at its first end (lower end in FIG. 3). The pin holder 14a is configured to nip an inner terminal (not shown) of a plug of the coaxial cable 6, thereby contacting and holding the same. The pin holder 14a is used for connecting the coaxial cable 6 of a TV receiver or the like. The pin holder 14a is disposed inside the recess 16 through a through hole 16a formed in the bottom of the recess 16. The inner terminal receiving member 14 is formed with a connecting portion 14d at its second end (upper end in FIG. 3). The connecting portion 14d is configured to contact and hold the inner portion 61 of the coaxial cable 6. The connecting portion 14d is adapted in use to be connected to the coaxial cable 6 preliminarily wired behind a wall.

The inner terminal receiving member 14 further is integrally formed with a plate-shaped connection piece 14b. The connection piece 14b is connected to an anode terminal of the light emitting diode LD1. Further, the connection pierce 14b is formed with an insertion hole 14c penetrating through its thickness direction. The anode terminal of the light emitting diode LD1 is inserted into the insertion hole 14c and soldered to the connection piece 14b. Therefore, the anode terminal of the light emitting diode LD1 is electrically connected to the inner terminal receiving member 14.

In the information outlet 1 of the present embodiment, the inner terminal receiving member 14, outer terminal receiving member 15, and recess 16 constitute an coaxial connection unit (plug connection unit) A adapted in use to be detachably connected to the plug (not shown) of the coaxial cable 6 of the TV receiver or the like. While the plug of the coaxial cable 6 is connected to the coaxial connection unit A, the inner terminal and outer terminal of the plug are contacted with the inner terminal receiving member 14 and outer terminal receiving member 15, respectively.

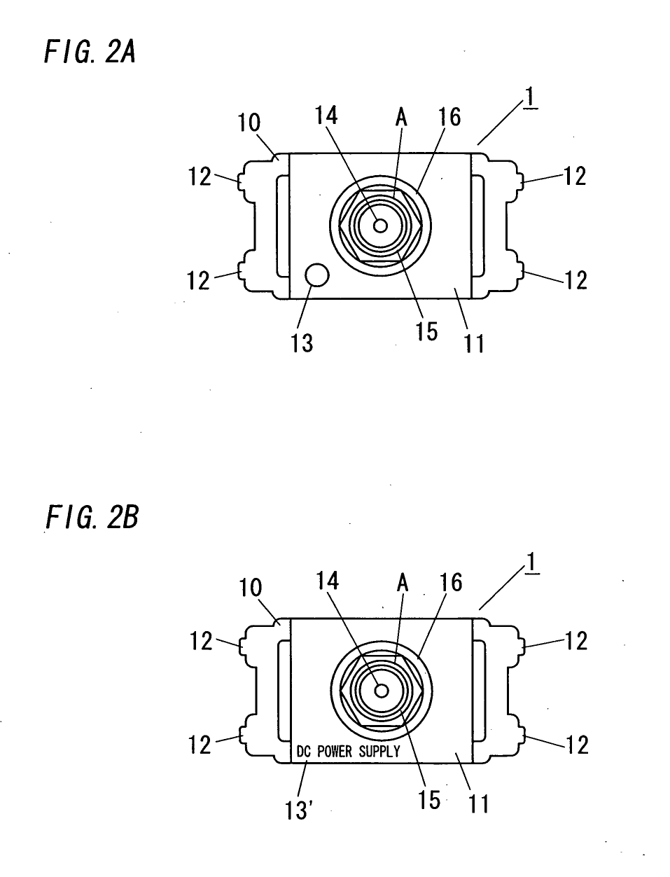

By the way, as shown in FIGS. 1 and 2A, the boss portion 11 is formed in its front surface with a translucency window portion 13. That is, the translucency window portion 13 is formed in a portion of the housing 10 where a user can see after the information outlet 1 is embedded in the wall. The translucency window portion 13 is made of a material which can pass the light emitted from the light emitting diode LD1. That is, the light from the light emitting diode LD1 is emitted to outside of the housing 10 via the translucency window portion 13.

The shield plate 17 is attached to the rear surface of the housing 10. The shield plate 17 is made of metals and shaped into a plate-like configuration. The shield plate 17 has an outer periphery generally coincident with an inner periphery of the opening in the rear surface of the housing 10. The shield plate 17 is integrally formed at its opposite longitudinal ends with crimping pieces 17a which project towards the housing 10. In order to attach the shield plate 17 to the housing 10, it is sufficient to fit the shield plate 17 into the opening of the rear surface of the housing 10 so as to press each of the crimping pieces 17a against an inner periphery of the housing 10. That is, the shield plate 17 is pressed into the opening of the rear surface of the housing 10.

The shield plate 17 is formed to have a notch 18. The notch 18 is used for projecting the connection portion 14d of the inner terminal receiving member 14 toward an outside of the rear surface of the housing 10. The shield plate 17 is formed with a bearing piece 17b on a surface opposite to the housing 10. The bearing pieces 17b are formed on opposite sides of the notch 18 in a longitudinal direction of the shield plate 17 respectively. The bearing piece 17b is adapted to be rotatively coupled to a clasp 20.

The clasp 20 is used for securing the coaxial cable 6 to the shield plate 17 so as to prevent the coaxial cable 6 from receiving tension. The clasp 20 includes a pressing portion 20b shaped into an arc shape and configured to press the coaxial cable 6. To wedge the coaxial cable 6 between the pressing portion 20b and the shield plate 17 secures the coaxial cable 6 to the shield plate 17. The coaxial cable 6 is secured to the shield plate 17 such that the outer conductor 63 exposed by eliminating a part of the sheath 64 of the coaxial cable 6 contacts to the shield plate 17. Therefore, the shield plate 17 is electrically connected to the outer conductor 63.

Support pieces 20a are respectively formed on opposite ends of the pressing portion 20b. An apex of each of the support pieces 20a is bent outward. The clasp 20 is rotatively coupled to the shield plate 17 by fitting the apex of each of the support pieces 20a into a notch portion (not shown) of the corresponding bearing piece 17b. A fixing piece 20c is integrally formed on one end of the pressing portion 20b. A screw 21 is attached to the fixing piece 20c such that the screw 21 is not easily uncoupled from the fixing piece 20c. The clasp 20 is fixed to the shield plate 17 by turning the screw 21 into a screw hole (not shown) provided to the shield plate 17. In short, the clasp 20 is secured to the shield plate 17 in a condition where the coaxial cable 6 is wedged between the pressing portion 20b and the shield plate 17. In this case, it is possible to certainly secure the coaxial cable 6 to the shield plate 17.

The dielectric plate 19 is shaped into a rectangular shape and is made of a dielectric resin. The dielectric plate 19 is attached to a surface (lower surface in FIG. 3) of the shield plate 17 adjacent to the housing 10. The dielectric plate 19 is integrally formed with a contact piece 19a on its first end in its lateral direction. The contact piece 19a projects from a surface of the dielectric plate 19 opposite to the shield plate 17. The contact piece 19 has a length such that the contact piece 19 contacts an inner bottom of the boss portion 11 in a condition (attachment condition) where the dielectric plate 19 and shield plate 17 are attached to the housing 10. The dielectric plate 19 is formed with a groove 19d connected to the notch 18 of the shield plate 17.

The dielectric plate 19 is formed with a rectangular shaped insertion hole 19b extending in its thickness direction. The insertion hole 19b is used for electrically connecting one leg 15a of the outer terminal receiving member 15 to the shield plate 17. A concave portion 17d is formed on a portion opposed to the insertion hole 19b, in the shield plate 17. The concave portion 17d is configured to be fitted the leg 15a into. Therefore, to fit one leg 15a of the outer terminal receiving member 15 into the concave portion 17d via the insertion hole 19b electrically connects the outer terminal receiving member 15 to the shield plate 17.

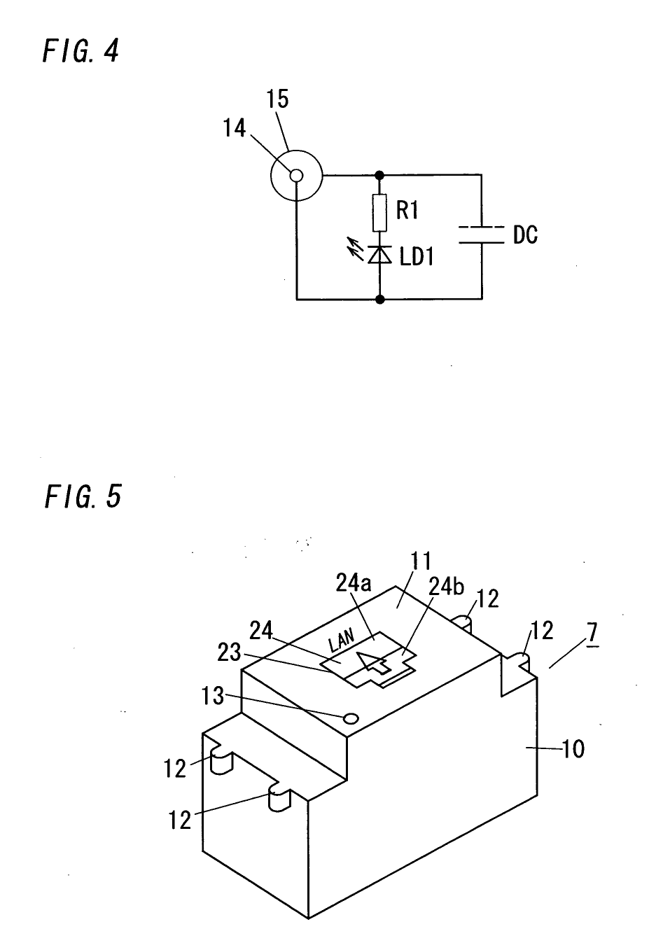

The dielectric plate 19 further is formed with a circular shaped insertion hole 19c extending in its thickness direction. The insertion hole 19c is used for electrically connecting a cathode terminal of the light emitting diode LD1 to the shield plate 17. The shield plate 17 has an insertion hole 17c extending in its thickness direction. The insertion hole 17c is connected to the insertion hole 19c. In the information outlet 1 of the present embodiment, one terminal of the resistor R1 penetrating through the insertion holes 19c and 17c is soldered to the shield plate 17. Another terminal of the resistor R1 is connected to the cathode terminal of the light emitting diode LD1. As described in the above, the outer terminal receiving member 15 is electrically connected to the shield plate 17. Therefore, as shown in FIG. 4, the cathode of the light emitting diode LD1 is electrically connected to the outer terminal receiving member 15 via the resistor R1. The resistor R1 is used for appropriately limiting a current flowing through the light emitting diode LD1.

In the aforementioned information outlet 1 of the present embodiment, the light emitting diode LD1 is interposed between the inner terminal receiving member 14 and the outer terminal receiving member 15.

The distributor 5 includes an AC/DC converter (not shown). This AC/DC converter is configured to convert AC power received from the commercial power source AC connected to the distributor 5 as shown in FIG. 9 into DC power. In short, the distributor 5 functions as a DC power source. The distributor 5 supplies DC power to the receiving amplifier 4 via the coaxial cable 6. That is, the distributor 5 is used as a power source for the receiving amplifier 4. The distributor 5 further supplies DC power to the information outlet 1 via the coaxial cable 6. Thus, the distributor 5 applies a predetermined DC voltage between the inner conductor 61 and outer conductor 63 of the coaxial cable 6. The distributor 5 superimposes a data signal such as an audio signal and video signal on the DC voltage, thereby transmitting the audio signal or video signal to the TV receiver or the like.

In the coaxial cable 6, the inner conductor 61 is used as a high potential side (positive electrode of the DC power source DC), and the outer conductor 63 is used as a low potential. side (negative electrode of the DC power source DC). Therefore, in the information outlet 1 of the present embodiment, the inner terminal receiving member 14 connected to the inner conductor 61 acts as the high potential side, and the outer terminal receiving member 15 connected to the outer conductor 63 acts as the low potential side.

Accordingly, while the distributor 5 supplies DC power to the information outlet 1, the DC voltage from the distributor 5 is applied between the anode terminal and cathode terminal of the light emitting diode LD1. Therefore, the light emitting diode LD1 is turned on. (the light emitting diode LD1 emits light). The light emitted from the light emitting diode LD1 is transmitted to the outside of the housing 10 via the translucency window portion 13. By contrast, while the distributor 5 does not supply DC power to the information outlet 1, the DC voltage from the distributor 5 is not applied between the anode terminal and cathode terminal of the light emitting diode LD1. Therefore, the light emitting diode LD1 is not turned on. It is noted that a threshold voltage of the light emitting diode LD1 is higher than a voltage of the data signal transmitted by the distributor 5 and is lower than the DC voltage applied by the distributor 5.

As discussed previously, the information outlet 1 of the present embodiment includes the housing (case) 10, and the coaxial connection unit (plug connection unit) A provided to the housing 10 and adapted in use to be detachably connected to the plug. The coaxial connection unit A is configured to send the data signal transmitted from the distributor 5 to the connected plug and supply DC power supplied from the distributor 5 to the same.

The light emitting diode LD1 emits light while the DC power is supplied to the coaxial connection unit A from the distributor 5, and the light emitted from the light emitting diode LD1 is transmitted to the outside of the housing 10 via the translucency window portion 13. Therefore, in the information outlet 1 of the present embodiment, the light emitting diode LD1 and translucency window portion 13 constitute a display unit configured to indicate a status that the DC power is being available.

As described in the above, according to the information outlet 1 of the present embodiment, by means of watching the aforementioned display unit provided to the housing 10, a user can easily judge whether or not the DC power is being supplied.

Especially, the display unit includes the light emitting diode (illuminant) LD1 interposed between the inner terminal receiving member 14 and outer terminal receiving member 15 of the coaxial connection unit A. The light emitting diode LD1 emits light by the DC power supplied to the coaxial connection unit A, that is, DC voltage applied between the inner terminal receiving member 14 and outer terminal receiving member 15.

Thus, the light emitting diode LD1 emits light while the DC power is supplied to the coaxial connection unit A, and does not emit the light while the DC power is not supplied to the coaxial connection unit A. Therefore, by means of watching the translucency window portion 13, a user can easily judge whether or not the DC power is being supplied. Further, the distributor 5 configured to supply DC power to the information outlet 1 is adopted as a power source for supplying DC power to the light emitting diode LD1. In short, the information outlet 1 need not include a power source adapted in use to turn on the light emitting diode LD1. As a result, it is possible to suppress the rise in a production cost.

Although the light emitting diode LD1 and the translucency window portion 13 constitute the display unit in the aforementioned instance, the display unit may be a letter display unit 13′ displaying letters such as “DC power supply” and the like, as shown in FIG. 2B. The letters of the letter display unit 13′ is not limited to “DC power supply”, and the letter display unit 13′ may be a letter where a user can recognize the DC power is being available. The display unit 13 further may be a symbol where a user can recognize the DC power is being available.

### Second Embodiment

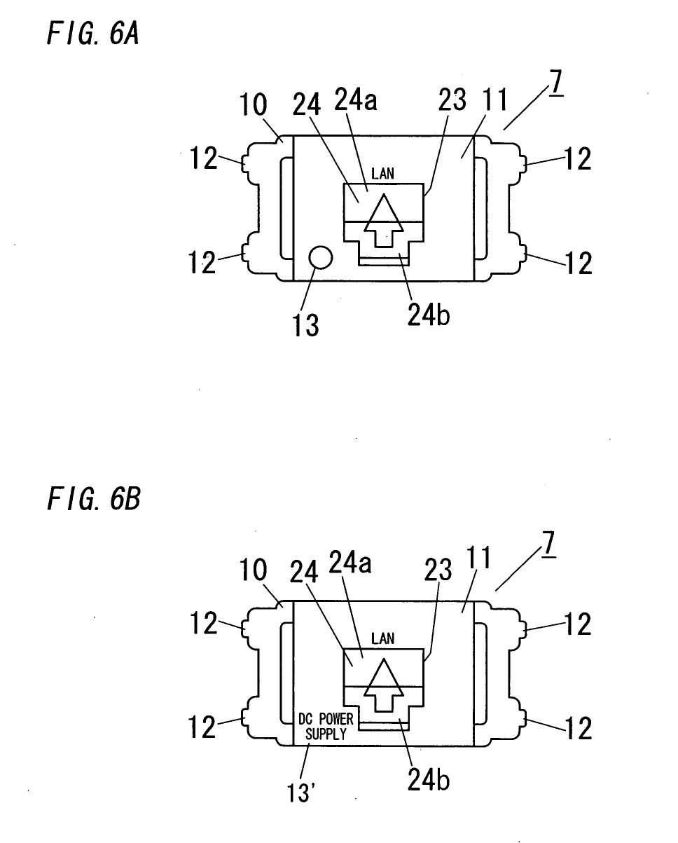

The information outlet 7 in accordance with the second embodiment is an information modular jack 7 for LAN, as shown in FIGS. 5 and 6. The information outlet 7 includes the housing (case) 10. The housing 10 is configured to house parts constituting a plug connection unit 8 shown in FIG. 8, three light emitting diodes (illuminants) LD2 to LD4, and three current-limiting resistors R2 to R4.

The housing 10 is a synthetic resin molded product and is shaped into an approximately rectangular box. The housing 10 is dimensioned into the aforementioned single unit module. The housing 10 is formed at its opposite longitudinal ends respectively with two latch protrusions 12 used for attaching the housing 10 to the fixture frame. The housing 10 is attached to the fixture frame by fitting the latch protrusion 12 into the corresponding latch portion (not shown) of the fixture frame. The housing 10 is provided in its entire rear surface (lower end of FIG. 1) with the opening.

The housing 10 is integrally formed on its front surface (upper surface in FIG. 1) with the approximately rectangular boss portion 11. The boss portion 11 is formed to have the length along its longitudinal direction approximately identical to the opening length along the lateral direction of the opening window. The boss portion 11 is formed in its center with an aperture window 23. A shutter 24 is located inside the aperture window 23. The shutter 24 is configured to move between an opening position where the shutter 24 opens the aperture window 23 and a closing position where the shutter 24 closes the aperture window 23. In the graphically-illustrated instance, the shutter 24 is constituted by two doors 24a and 24b. Since the shutter 24 is well known, a detailed explanation of the shutter 24 is omitted.

As shown in FIGS. 5 and 6A, the boss portion 11 is formed with the translucency window portion 13 in its front surface. The translucency window portion 13 is made of a material which can pass light emitted from each of the light emitting diodes LD2 to LD4. That is, the light emitted from each of the light emitting diodes LD2 to LD4 is emitted to the outside of the housing 10 via the translucency window portion 13.

As shown in FIG. 9, the information outlet 7 is connected to a hub 30 located in the house via a twisted pair cable (e.g. an enhance category 5 cable) 32. Devices connected to the information outlets 7 can communicate with each other via the hub (external device) 30.

The hub 30 includes an AC/DC converter (not shown). This AC/DC converter is configured to convert AC power received from the commercial power source AC connected to the hub 30 as shown in FIG. 9 into DC power. In short, the hub 30 has a function as a DC power source. The hub 30 supplies DC power to the information outlet 7 via the twisted pair cable 32. That is, the hub 30 is used as a power source for the information outlet 7.

The DC power output from the AC/DC converter of the hub 30 is supplied to the information outlet 7 via the twisted pair cable 32 by means of a technique called as “PoE (Power over Ethernet (registered trademark))”. The PoE defines a technique of supplying power via the twisted pair cable with a performance equal to or higher than the category 5 cable used in the Ethernet (registered trademark). The PoE is a standard (IEEE 802.3af) used in a network system conformed to a standard such as 10 BASE-T and 100 BASE-TX (IEEE 802.3u).

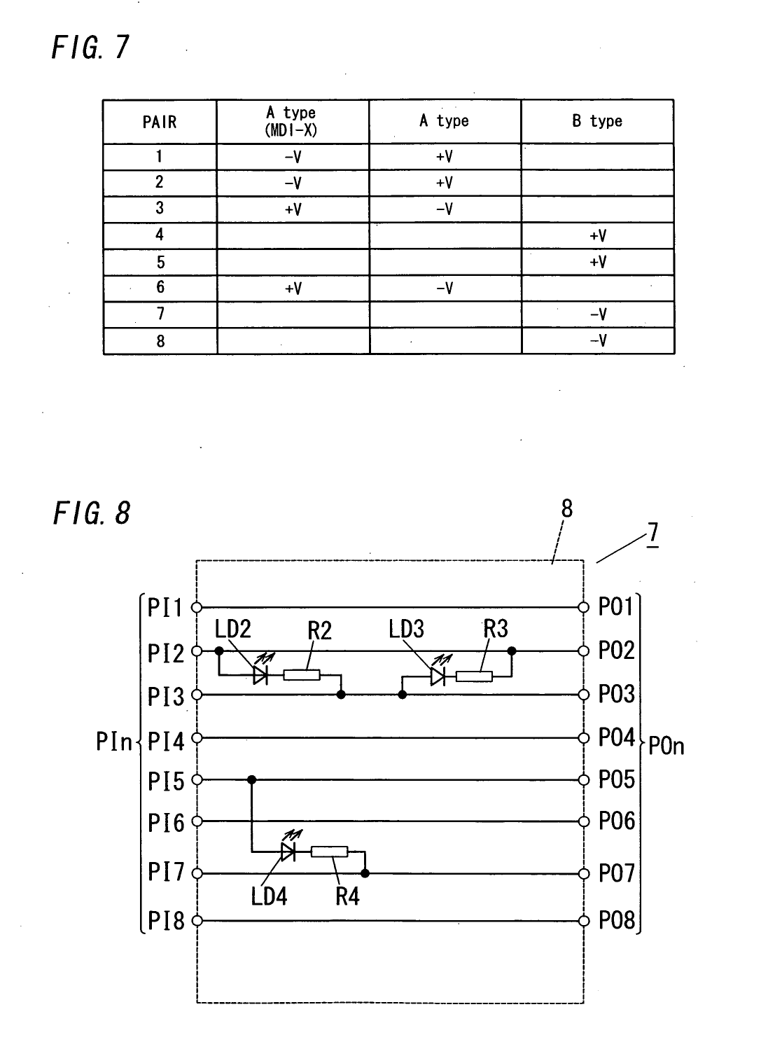

FIG. 7 illustrates a pin assignment of the twisted pair cable used in 10 BASE-T or 100 BASE-TX. In the twisted pair cable, a 1st pin, 2nd pin, 3rd pin, and 6th pin are used for transmission of a data signal. Power supply is categorized into an A type and a B type. In the A type, a 1st pin, 2nd pin, 3rd pin, and 6th pin assigned for transmission of a data signal are used for power feeding. That is, in the A type, a data signal is superimposed on DC voltage. Meanwhile, in the B type, a 4th pin, 5th pin, 7th pin, and 8th pin not assigned for transmission of a data signal are used for power feeding. The A type is classified into two types according to a polarity of DC voltage. In the following explanation, “A type (MDI)” is defined as the A type where the 1st and 2nd pins are used for receiving a high potential and the 3rd and 6th pins are used for receiving a low potential, and “A type (MDI-X)” is defined as the A type where the 3rd and 6th pins are used for receiving a high potential and the 1st and 2nd pins are used for receiving a low potential.

A modular connector is provided at an end of the twisted pair cable with 8 wires used in such as 10 base-T and 100 base-TX.

The information outlet 7 of the present embodiment is a so-called RJ45 jack connected to the aforementioned modular connector. The housing 10 of the information outlet 7 is provided with the plug connection unit 8 (see FIG. 8) adapted in use to be detachably connected to the aforementioned modular connector (plug).

As shown in FIG. 8, the plug connection unit 8 includes a plurality of input terminals PIn (n=1, 2, . . . , 8) and a plurality of output terminals POn (n=1, 2, . . . , 8). The input terminals are connected to the output terminals POn in one-to-one correspondence (the input terminal PIn is connected to the output terminal POn having the same suffix). In the plug connection unit 8, the output terminal POn is a terminal receiving member configured to contact with the pin being a terminal of the aforementioned modular connector. The output terminals PO1 to PO8 are corresponding to the 1st to 8th pins of the aforementioned modular connector, respectively.

The three light emitting diodes (illuminants) LD2 to LD4 and three current-limiting resistors R2 to R4 are housed in the housing 10 of the information outlet 7. As shown in FIGS. 5 and 6A, the boss portion 11 is formed with the translucency window portion 13 in its front surface. The translucency window portion 13 is made of the material which can pass light emitted from each of the light emitting diodes LD2 to LD4. That is, the light emitted from each of the light emitting diodes LD2 to LD4 is emitted to the outside of the housing 10 via the translucency window portion 13.

In the information outlet 7 of the present embodiment, the light emitting diode LD2 has its anode terminal connected to the output terminal PO2 and its cathode terminal connected to the output terminal PO3 via the resistor R2. The light emitting diode LD3 has its anode terminal connected to the output terminal PO3 and its cathode terminal connected to the output terminal PO2 via the resistor R3. The light emitting diode LD4 has its anode terminal connected to the output terminal PO5 and its cathode terminal connected to the output terminal PO7 via the resistor R4.

Accordingly, while DC power is supplied from the hub 30 according to the A type (MDI), the light emitting device LD2 keeps its anode terminal higher in potential than its cathode terminal. Therefore, the light emitting diode LD2 emits light. The light from the light emitting diode LD2 is transmitted to the outside of the housing 10 through the translucency window portion 13. While DC power is supplied from the hub 30 according to the A type (MDI-X), the light emitting device LD3 keeps its anode terminal higher in potential than its cathode terminal. Therefore, the light emitting diode LD3 emits light. The light from the light emitting diode LD3 is transmitted to the outside of the housing 10 through the translucency window portion 13. While DC power is supplied from the hub 30 according to the B type, the light emitting device LD4 keeps its anode terminal higher in potential than its cathode terminal. Therefore, the light emitting diode LD4 emits light. The light from the light emitting diode LD4 is transmitted to the outside of the housing 10 through the translucency window portion 13. While no DC power is supplied form the hub 30, no DC voltage is applied between the anode terminal and cathode terminal of each of the light emitting diodes LD2 and LD4. Accordingly each of the light emitting diodes LD2 to LD4 does not emit light. It is noted that a threshold voltage of each of the light emitting diodes LD2 to LD4 is higher than a voltage of the data signal transmitted by the hub 30 and is lower than the DC voltage applied by the hub 30.

That is, while the plug connection unit 8 receives DC power, any one of the light emitting diodes LD2 to LD4 emits light in accordance with the power supply type.

As discussed previously, the information outlet 7 of the present embodiment includes the housing (case) 10, and the plug connection unit 8 provided to the housing 10 and adapted in use to be detachably connected to the plug. The plug connection unit 8 is configured to send the data signal transmitted from the hub 30 to the plug and supply DC power supplied from the hub 30 to the same.

In the information outlet 7, any one of the light emitting diodes LD2 to LD4 emits light while the DC power is supplied to the plug connection unit 8 from the hub 30, and the light emitted from any one of the light emitting diodes LD2 to LD4 is transmitted to the outside of the housing 10 via the translucency window portion 13. Therefore, in the information outlet 7 of the present embodiment, the light emitting diodes LD2 to LD4 and translucency window portion 13 constitute the display unit configured to indicate the status that the DC power is being available.

As described in the above, according to the information outlet 7 of the present embodiment, by means of watching the aforementioned display unit provided to the housing 10, a user can easily judge whether or not the DC power is being supplied.

Especially, the light emitting diodes LD2 to LD4 emit light by the DC power supplied from the hub 30. Thus, any one of the light emitting diodes LD2 to LD4 emits light while the DC power is supplied from the hub 30, and does not emit the light while the DC power is not supplied from the hub 30. Therefore, by means of watching the translucency window portion 13, a user can easily judge whether or not the DC power is being supplied. Further, the hub 30 configured to supply DC power to the information outlet 7 is adopted as a power source for supplying DC power to the light emitting diode LD2 to LD4. In short, the information outlet 7 need not include a power source adapted in use to turn on the light emitting diodes LD2 to LD4. As a result, it is possible to suppress the rise in a production cost.

Although the light emitting diodes LD2 to LD4 and the translucency window portion 13 constitute the display unit in the aforementioned instance, the display unit may be the letter display unit 13′ displaying letters such as “DC power supply” and the like, as shown in FIG. 6B. The letters of the letter display unit 13′ is not limited to “DC power supply”, and the letter display unit 13′ may be a letter where a user can recognize the DC power is being available. The display unit 13 further may be a symbol where a user can recognize the DC power is being available.

1. An information outlet comprising:
a case;
a plug connection unit provided to said case and adapted in use to be detachably connected to a plug,
wherein said plug connection unit is configured to send a data signal to the plug and supply DC power to the same,
said case being provided with a display unit configured to indicate a status that the DC power supply is being available.

2. An information outlet as set in forth claim 1, wherein
said display unit includes an illuminant electrically connected to said plug connection unit,
said illuminant being configured to emit light by use of the DC power supplied to said plug connection unit.
